(19) United States
(12) Patent Application Publication
(10) Pub. No.: US 2003/0015878 A1
(43) Pub. Date: Jan. 23, 2003

(54) Child safety feature for a vehicle door latch

(76) Inventor: Sidney Edward Fisher, Worcestershire (GB)

Correspondence Address: CARLSON, GASKEY & OLDS, P.C., 400 WEST MAPLE ROAD, SUITE 350, BIRMINGHAM, MI, 48009, US

(21) Appl. No.: 10/194,436

(22) Filed: Jul. 12, 2002

(30) Foreign Application Priority Data
Jul. 18, 2001 (GB) 01 17446.5

(51) Int. Cl. E05B 3/00

(52) U.S. Cl. 292/1; 292/336.3

(57) ABSTRACT

A vehicle door latch operably connected to a manually operable element selectively operable to disable a transmission path between the vehicle door latch and an internal door release means thereby to prevent release of the vehicle door latch by the internal door release means, wherein the manually operable element comprises means of illumination.

This application claims priority to Great Britain patent application numbers GB 01 17446.5 filed Jul. 18, 2001.

### BACKGROUND OF THE INVENTION

This invention relates to child safety features on vehicle door latches, particularly to the visibility of child safety features.

Most vehicle doors can be opened from both inside and outside. When a passenger is a child, curiosity may lead to the child opening the door from the inside when it is not safe to do so. For this reason it is desirable to be able to stop a child being able to open the door from the inside.

It is known to have child safety features on vehicle door latches. Typically these can be turned on or off and when turned on prevent the door from being opened from the inside. However such child safety features are often difficult to locate, especially when there is a poor level of light such as at night. Also it is often difficult to tell if the child safety is on or off, again this is especially so in poor light conditions.

### SUMMARY OF THE INVENTION

It is an object of this invention to help overcome one or more of these problems, especially making a child safety feature easier to locate in the dark and/or to provide improvements in child safety feature for vehicle door latches.

According to a first aspect of the invention there is provided a vehicle door latch operably connected to a manually operable element moveable between enabled and disabled positions thereby to affect a transmission path between the vehicle door latch and an internal door release means thereby to respectively enable or disable release of the vehicle door latch by the internal door release means, further comprising means of illumination for the manually operable element and preferably, wherein the manually operable element comprises means of illumination.

Preferably the manually operable element is located on the shut face of a door which is inaccessible in use when the door is closed.

Preferably the illuminating means illuminates in the colour yellow.

Preferably the means of illumination is provided without combustion or perceptible heat, i.e. by luminescence. More preferably the means of illumination comprises a region of the manually operable element being luminescent such as phosphorescent or fluorescent.

Preferably the means of illumination displays a colour when the transmission path is disabled and a different colour when it is enabled.

Preferably the colour displayed when the transmission path is disabled is green and preferably the colour displayed when the transmission path is enabled is red.

In one embodiment of the invention the manually operable element comprises a lever moveable between first and second positions, selection of which position determines whether the transmission path is enabled or disabled.

In another embodiment of the invention the manually operable element comprises a rotatable component, the rotational position of which relative to the door latch determines whether the transmission path is disabled and more preferably may be rotated by insertion and rotation of a tool, such as a screwdriver.

Preferably the rotatable component comprises an indicator panel, the panel comprising two coloured sections which rotate with the component in which the two coloured sections are preferably red and green and/or luminescent.

According to a second aspect of the invention there is provided a vehicle door latch comprising a child safety feature having an illuminated actuator for enabling and disabling the child safety feature.

According to a third aspect of the invention there is provided a vehicle door incorporating a vehicle door latch, in which a shut face comprises an aperture adjacent to the vehicle door latch through which a colour is displayed and when the rotatable component is rotated, when the transmission path is disabled, a different colour is displayed through the aperture.

### BRIEF DESCRIPTION OF THE DRAWINGS

A vehicle door latch in accordance with the invention will now be described, by way of example only, with reference to the following drawings in which:

FIG. 1 is a schematic view of a side a vehicle including a door with a vehicle door latch according to the invention,

FIG. 2 is a view of a shut face of a vehicle door including a latch according to the invention,

FIG. 3 is a view of a second embodiment of a shut face of a vehicle door including a latch according to the invention, and

FIG. 4 is a view of a third embodiment of a shut face of a vehicle door including a latch according to the invention.

### DETAILED DESCRIPTION OF THE PREFERRED EMBODIMENT

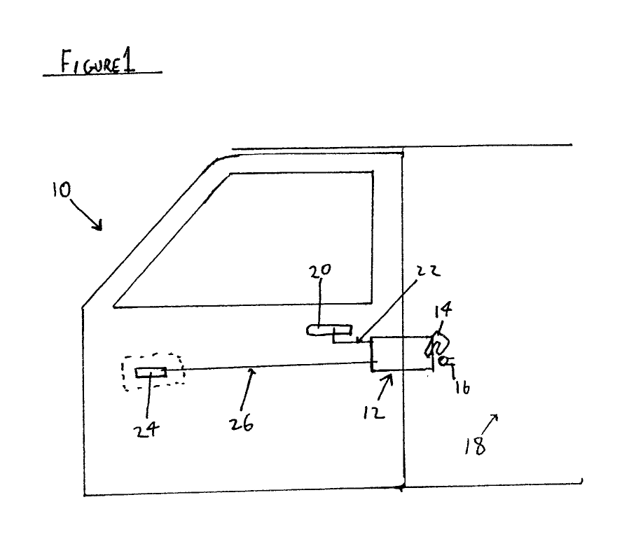

Referring to FIG. 1 there is shown a vehicle door 10 with a vehicle door latch 12 for latching and locking the door 10 to the vehicle 18. The vehicle door latch 12 comprises a latch bolt 14 which engages and disengages with a striker 16 connected to the vehicle 18 so as to allow closing and opening of the door. The latch bolt is retained in its closed position by a pawl (not shown).

The release of the latch 12 can be operated by an external door handle 20 when the latch is in an unlocked condition. The external handle 20 is connected to the pawl of the latch 12 by a transmission path 22 part of which could take the form of a rod and which allows release the latch 12 by pulling the handle 20. The latch 12 may also be released by an internal door handle 24. The internal handle 24 is connected to the pawl of the latch 12 by transmission path 26, typically part of which is in the form of a Bowden cable and usually works in a substantially similar way to external handle 20.

There is also provided a child safety feature housed in latch 12. This feature can be switched on or off. When the feature is switched off the latch 12 works as described above. When the feature is switched on, the transmission path 26 is disabled so that the internal handle 24 can no longer release the latch so the door cannot be opened from the inside. When the child safety feature is switched on, the latch may still be released by the external handle 20 when the latch is in an unlocked condition.

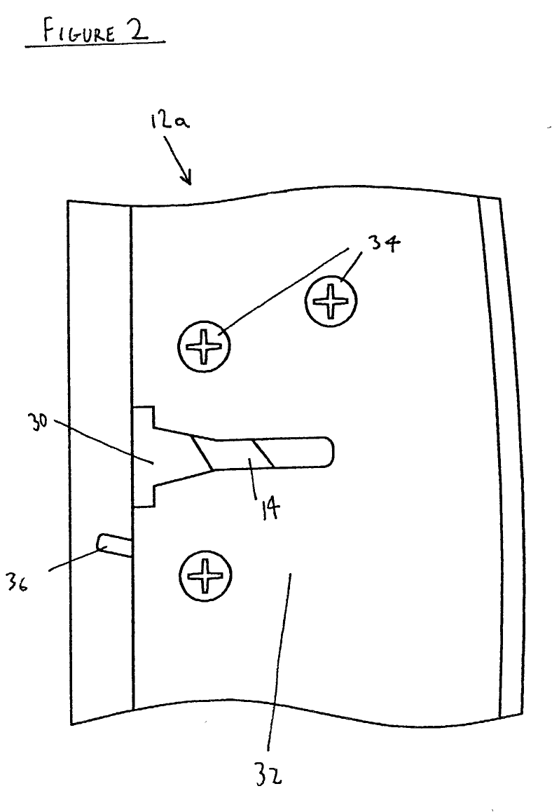

FIG. 2 shows a first embodiment of a vehicle door latch 12a most of which is concealed by the shut face 32 of the door. The latch bolt 14 is located within an aperture 30. The striker 16 enters through the aperture 30 to strike and engage the latch bolt 14. The vehicle door latch 12a is attached to the door 10 by screws 34.

The child safety feature is switched on or off by lever 36. The lever 36 may be pushed between an upwards position and a downwards position. In the upwards position the child safety feature is on. When pushed into the downwards position this turns off the child safety feature. Accordingly a manually operable element (lever 36) is provided to enable and disable the configuration.

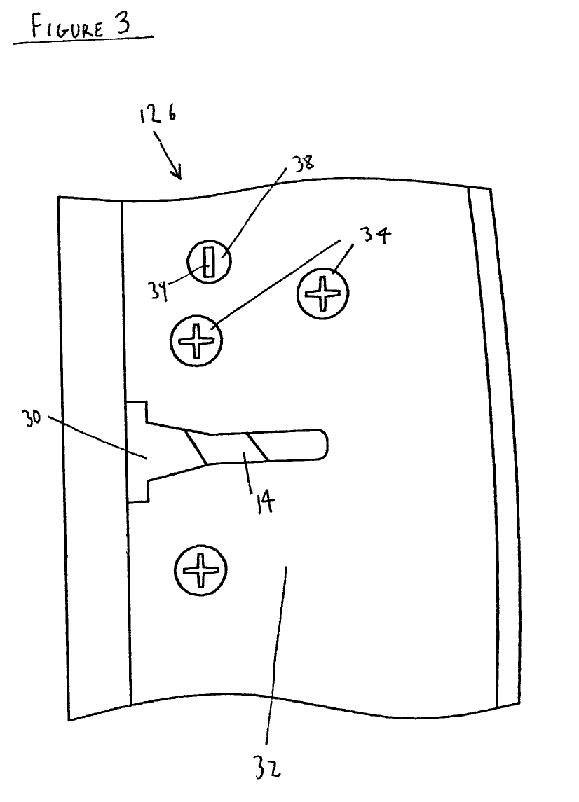

FIG. 3 shows a second embodiment of a vehicle door latch 12b similar to door latch 12a but with a different manually operable element. The child safety feature of the latch 12b is switched on or off by a rotatable component 38. The rotatable component 38 can be rotated by insertion of a tool such as a screwdriver into the slot 39. The component 38 has two rotational positions relative to the door latch 12 and the position it is in determines whether the transmission path is disabled or enabled, i.e. whether the child safety feature is on or off. When the slot 39 is vertical as shown in FIG. 2 the child safety feature is on. When the slot 39 is approximately twenty five degrees from vertical the child safety feature is off

The two manually operable elements 36 and 38 of the door latches 12a and 12b respectively are luminescent, emitting light without perceptible heat and preferably emitting yellow light. This helps the elements to be found even in poor light conditions or at night. The elements may use a fluorescent or phosphorescent paint coating or could be made from a luminescent plastic.

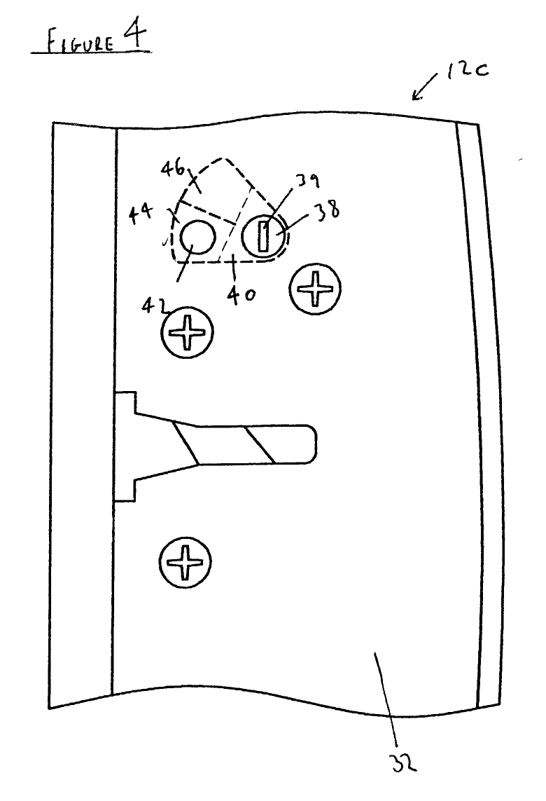

FIG. 4 shows a second embodiment of vehicle door latch 12c substantially similar to latch 12b except for the area surrounding the rotatable component 38. Sharing the axis of rotation of the component 38 is a triangular indicator panel 40. This panel 40 is fixed to the component 38 and rotates with it, behind the shut face 32.

In the shut face 32 of the door there is a circular aperture 42 which allows a user to view the surface of panel 40 behind the aperture 42. In FIG. 3 the surface behind the aperture is green section 44. Green section 44 is luminescent and emits green light, hence green light is visible through the aperture 40. This green light indicates that the child safety feature is switched on. Green is used because it is associated with “go” or “on”. Located approximately twenty five degrees about the axis of rotation of component 38 is a red section 46 hidden by the shut face 32. The red section 46 is luminescent and emits red light. However, when the switches are in the on position shown in FIG. 3 the red light is not visible to users. The red and green sections are luminescent in a similar way to the rotatable component 38.

When the rotatable component 38 is rotated through approximately twenty five degrees, anticlockwise when viewing FIG. 4, the child safety feature is turned off and the panel 40 is rotated by approximately twenty five degrees. In this position the surface behind the aperture 42 is the red section 46, and the green section 44 is hidden by the shut face 32. Red light is then visible through the aperture 40 and this red light indicates that the child safety feature is switched off. Red is used since this colour is associated with “danger” or “off” and represents an unsafe situation for children.

In the third embodiment shown in FIG. 4 an adult concerned about child safety can easily see if the child safety feature is on or off even in poor light conditions such as at night. He or she can also easily locate the yellow light emitting component 38 and change its position if required.

The foregoing description is only exemplary of the principles of the invention. Many modifications and variations of the present invention are possible in light of the above teachings. The preferred examples of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A vehicle door latch operably connected to a manually operable element moveable between an enabled position and a disabled position to affect a transmission path between the vehicle door latch and an internal door release mechanism respectively enable and disable release of the vehicle door latch by the internal door release mechanism, further comprising an illumination mechanism for the manually operable element.

2. The vehicle door latch as recited in claim 1 in which the manually operable elements is the illumination mechanism.

3. The vehicle door latch according to claim 1 in which the manually operable element is located on the shut face of a door which is inaccessible in use when the door is closed.

4. The vehicle door latch according to claim 1 in which the illuminating mechanism illuminates in yellow.

5. The vehicle door latch according to claim 1 in which the illumination mechanism is provided without heat.

6. The vehicle door latch according to claim 5 in which the illumination mechanism includes a region of the manually operable element being luminescent.

7. The vehicle door latch according to claim 6 wherein the manually operable element is phosphorescent.

8. The vehicle door latch according to claim 6 wherein the manually operable element is fluorescent.

9. The vehicle door latch according to claim 1 in which the illumination mechanism displays a color when the transmission path is disabled and a different colour when the transmission path is enabled.

10. The vehicle door latch according to claim 9 in which the color displayed when the transmission path is disabled is green.

11. The vehicle door latch according to claim 9 in which the color displayed when the transmission path is enabled is red.

12. The vehicle door latch according to claim 1 in which the manually operable element includes a lever moveable between a first position and a second position, selection of which position determines whether the transmission path is enabled or disabled.

13. The vehicle door latch according to claim 1 in which the manually operable element includes a rotatable component, the rotational position of which relative to the door latch determines if the transmission path is disabled.

14. The vehicle door latch according to claim 13 in which the rotatable component is rotatable by insertion and rotation of a tool.

15. The vehicle door latch according to claim 13 in which the rotatable component comprises an indicator panel, the panel including two colored sections which rotate with the component.

16. The vehicle door latch according to claim 15 in which the two colored sections are red and green.

17. The vehicle door latch according to claim 15 in which the two colored sections are luminescent.

18. A vehicle door latch including a child safety feature having an illuminated actuator for enabling and disabling the child safety feature.

19. A vehicle door comprising:
a vehicle door latch operably connected to a manually operable element including a rotatable component having an indicator panel with two colored sections which rotate with the rotatable component and moveable between an enabled position and a disabled position to affect a transmission path between the vehicle door latch and an internal door release mechanism respectively enable and disable release of the vehicle door latch by the internal door release mechanism, the rotational position of the rotatable component relative to the vehicle door latch determines if the transmission path is disabled; and
an illumination mechanism for the manually operable element in which a shut face of the door includes an aperture adjacent to the vehicle door latch through which part of the indicator panel is displayed such that with the manually operable element in different positions, different colors are displayed through the aperture,
